(19) United States
(12) Patent Application Publication
(10) Pub. No.: US 2017/0036437 A1
(43) Pub. Date: Feb. 9, 2017

(54) Industrial drying heat pump system for printing press

(71) Applicant: Guangdong Phnix Eco-energy Solution Ltd., Guangzhou (CN)

(72) Inventors: Linghua JIANG, Guangzhou (CN); Guangfu XIANG, Guangzhou (CN); Xiang GAO, Guangzhou (CN); Yuanhui LIU, Guangzhou (CN); Yi YI, Guangzhou (CN)

(21) Appl. No.: 14/834,985

(22) Filed: Aug. 25, 2015

(30) Foreign Application Priority Data
Aug. 3, 2015 (CN) 201510471608.7

(51) Int. Cl. B41F 23/04

(52) U.S. Cl. CPC B41F 23/04

(57) ABSTRACT

The present invention discloses an industrial drying heat pump system for printing press comprising drying unit, wherein the dryer units comprise a sensible heat exchanger having a fresh-air inlet surface, a fresh-air outlet surface being opposite to the fresh-air inlet surface, a return-air inlet surface, and a return-air outlet surface being opposite to the return-air inlet surface; an air inlet is configured in the drying unit, facing towards the fresh-air inlet surface, and an air return inlet is configured in the drying unit, facing towards the return-air inlet surface; a condenser having a condenser air inlet surface, the condenser air inlet surface and the fresh-air outlet surface are configured to face each other and have an identical area; an evaporator having an evaporator air inlet surface, the evaporator air inlet surface and the return-air outlet surface are configured to face each other and have an identical area. The present invention has a simple arrangement, low wind resistance and high efficiencies of air flow and heat recovery.

### CROSS REFERENCE TO RELATED APPLICATION

This application claims priority to Chinese Application No. CN 201510471608.7 having a filing date of Aug. 3, 2015, the entire contents of which are hereby incorporated by reference.

### TECHNICAL FIELD

The present invention relates to the field of the drying apparatus, in particular to a drying heat pump system for printing press, having low wind resistance and high efficiencies of air supply/heat recovery.

### BACKGROUND

Drying heat pumps system was used widely in the printing industry, for example, for drying presswork, surface spraying of products, electronic elements, thermosetting cement, heat-set ink, spurt draws, printing, clothing printing, dyeing and printing, foodstuff, etc, due to its high energy-efficiency, flexible control mode and environment-friendly properties.

Conventional drying heat pump system for printing press consists of drying unit which is connected to a drying chamber. Its work principle is that, fresh air was heated by the drying unit and then entered the drying chamber to dry desired presswork, and the moist/hot air generated during the drying process is recycled back to the drying unit in which the hot air will be heat-exchanged with fresh air, thereby heat energy can be recycled. Therefore the performance of drying unit will rely on its own heat energy efficiency.

Chinese patent CN204020225U disclosed an air duct system for drying unit for printing press, wherein FIGS. 1 & 2 show the structure of the duct, the external panels of the duct are omitted for depicting the internal structure of the duct clearer. As shown in FIGS. 1 & 2, the portions 2, 4, 9, 10 & 12 are constituted with the external panels respectively, to form a first air inlet duct 2, a second air inlet duct 4, a first air return duct 9, a second air return duct 10 and an air outlet duct 12. The unit comprises an air outlet 13, an air inlet 1, a sensible heat exchanger 3, condensers 5 and evaporators 11 configured adjacently and horizontally, and a condensation fan 6.

Fresh air entered the sensible heat exchanger 3 through the air inlet 1 and the first air inlet duct 2 which are configured at the rear of the drying unit, then the fresh air is heat-exchanged with the hot air, and the heated fresh air enters the condenser 5 through the second air inlet duct 4 at the front of the drying unit, for further heating, the further heated air is blown into the drying chamber by the condensation fan 6 and an air outlet 7, for drying the presswork.

The moist/hot air generated during the drying process enters the sensible heat exchanger 3 through an air return inlet 8 and the first air return duct 9, and is then heat-exchanged with the fresh air, the cooled air is induced to the evaporator 11 through the second air return duct 10, for further cooling, and is eventually exhausted from the air outlet duct 12 and air outlet 13 which are configured at the rear of the drying unit.

However, the mentioned drying unit has the following drawbacks:

(1) The structure of internal ducts is complicated, causing high wind resistance, and thereby reducing the efficiencies of air-supply and heat recovery.

(2) The first air inlet duct 2, the second air inlet duct 4, the first air return duct 9, the second air return duct 10 and the air outlet duct 12 are constituted as airproof ducts by means of external panels, however air leakage will occur if the external panels are slackened off, reducing the performance of air-supply and heat recovery.

### SUMMARY OF THE INVENTION

There is provided a drying heat pump system for printing press, having simple duct arrangement, low wind resistance and high efficiencies of air flow and heat recovery.

The drying heat pump system for printing press comprises dryer unit, wherein said dryer unit comprises
a sensible heat exchanger having a fresh-air inlet surface, a fresh-air outlet surface being opposite to the fresh-air inlet surface, a return-air inlet surface, and a return-air outlet surface being opposite to the return-air inlet surface; an air inlet is configured in the drying unit, facing towards the fresh-air inlet surface, and an air return inlet is configured in the drying unit, facing towards the return-air inlet surface;
a condenser having a condenser air inlet surface, the condenser air inlet surface and the fresh-air outlet surface are configured to face each other and have an identical area;
an evaporator having an evaporator air inlet surface, the evaporator air inlet surface and the return-air outlet surface are configured to face each other and have an identical area.

In some embodiments, a first air inlet interval is provided between the air inlet and the fresh-air inlet surface, and an airproof material is used to surround the first air inlet interval, to form a first airproof air inlet duct.

Furthermore, a second air inlet interval is provided between the fresh-air outlet surface and the condenser air inlet surface, and an airproof material is used to surround the second air inlet interval, to form a second airproof air inlet duct.

Furthermore, an air return interval is provided between the return-air outlet surface and the evaporator air inlet surface, and an airproof material is used to surround the air return interval, to form an airproof air return duct.

In some embodiments, a return-air guide ring is configured between the return-air inlet surface and the air return inlet, for uniformly inducing return air from the air return inlet to the return-air inlet surface.

Furthermore, the evaporator has an evaporator air outlet surface, and an exhaust guide ring is configured between the evaporator air outlet surface and an air outlet provided in the drying unit.

Furthermore, the condenser has a condenser air outlet surface, and the drying unit also comprises a condensation fan that is connected to the condenser air outlet surface, an air guide ring is configured between the condensation fan and the condenser air outlet surface.

In some embodiments, the heat pump also comprises an air volume detector which comprises a duct and a differential pressure transmitter connected to the duct.

The drying unit comprises an air outlet connected to the condensation fan, and the duct is configured at the air outlet.

In some embodiments, the air outlet and the air return inlet are both provided on an identical side of the drying unit.

In some embodiments, the air inlet and the air outlet are both provided on an identical side of the drying unit.

Compared to the prior art, the present invention possesses the following advantages:

The industrial drying heat pump system for printing press, according to the present invention, eliminates complicated ducts designs between the sensible heat exchanger and the air inlet, between the sensible heat exchanger and the condenser, between the sensible heat exchanger and the evaporator. Instead, the present invention is configured in the manner of that the condenser air inlet surface and the fresh-air outlet surface are configured to face each other and have an identical area, the evaporator air inlet surface and the return-air outlet surface are configured to face each other and have an identical area. Thus, the fresh air enters the fresh-air inlet surface, then enters the condenser air inlet surface through the fresh-air outlet surface, and the return air enters the evaporator air inlet surface through the return-air outlet surface. The present invention has a compact structure and a simple arrangement, and eliminates complicated ducts design, such structure and arrangement reduce wind resistance and greatly improve the efficiencies of air flow/heat recovery.

Furthermore, the first air inlet duct, formed by airproof materials surrounding the first air inlet interval, is configured between the air inlet and the fresh-air inlet surface; the second air inlet duct, formed by airproof materials surrounding the second air inlet interval, is configured between the fresh-air outlet surface and the condenser air inlet surface; the air return duct, formed by airproof materials surrounding the air return interval, is configured between the return-air outlet surface and the evaporator air inlet surface. Also, condenser air inlet surface and the fresh-air outlet surface have an identical area, and the return-air outlet surface and the evaporator air inlet surface have an identical area. This ensures that air can enter the sensible heat exchanger, the condenser and the evaporator uniformly, and energy consumption due to wind resistance can be reduced.

Furthermore, the drying heat pump system according to the present invention is also provided with the system comprises an air volume detector at the air outlet, which measures an air volume. Based on the required air volume, the actual air volume may be adjusted. The embodiment can adjust the air volume precisely, and save energy.

### BRIEF DESCRIPTION OF DRAWINGS

FIG. 1 is a front schematic view of air duct system of conventional drying unit for printing press.

FIG. 2 is a back schematic view of air duct system of conventional drying unit for printing press.

FIG. 3 is a schematic view of sensible heat exchanger of drying heat pump system according to the present invention.

FIG. 4 is a schematic view of condenser of drying heat pump system according to the present invention.

FIG. 5 is a schematic view of evaporator of drying heat pump system according to the present invention.

FIG. 6 is a cross-section view of dryer unit in drying heat pump system according to the present invention.

FIG. 7 is a structural schematic view of dryer unit in drying heat pump system according to the present invention.

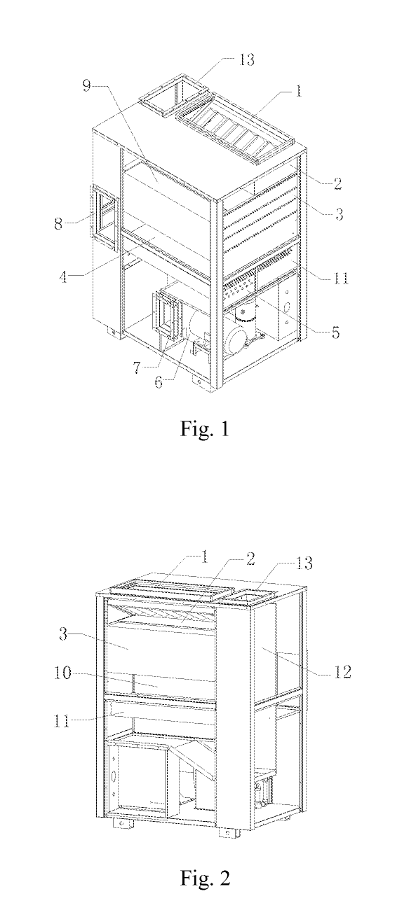

### DETAILED DESCRIPTION OF THE INVENTION

The present invention will be described in detailed with the accompanying figures and with reference to specific embodiment. The exemplary embodiment is described hereinafter for better understanding the present invention only, and is not any limitation to the present invention.

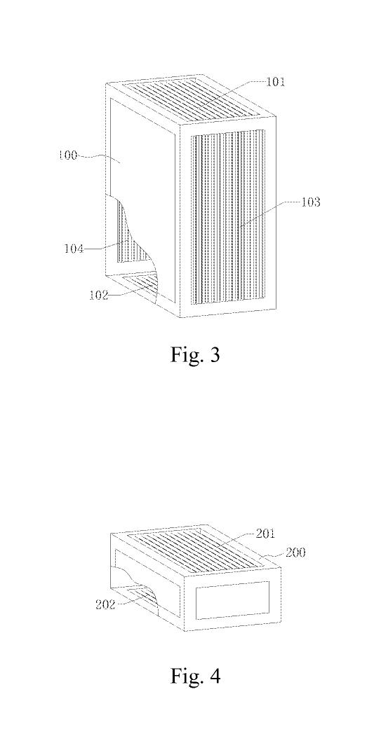

As shown in FIG. 3, there is a specific embodiment of a sensible heat exchanger 100 of a drying heat pump system for printing press according to the present invention, wherein the sensible heat exchanger 100 has a fresh-air inlet surface 101, a fresh-air outlet surface 102 being opposite to the fresh-air inlet surface 101, a return-air inlet surface 103, and a return-air outlet surface 104 being opposite to the return-air inlet surface 103. For better understanding, the surfaces 102 and 104 are shown here by the partial cross-section views. The sensible heat exchanger 100 shown here is cuboid.

As shown in FIG. 4, there is a specific embodiment of a condenser 200 according to the present invention, wherein the condenser 200 has a condenser air inlet surface 201 and a condenser air outlet surface 202. For better understanding, the surface 202 is shown here by the partial cross-section view. The condenser 200 shown here is cuboid, wherein the surface 201 and the surface 102 have an identical area, and are faced each other.

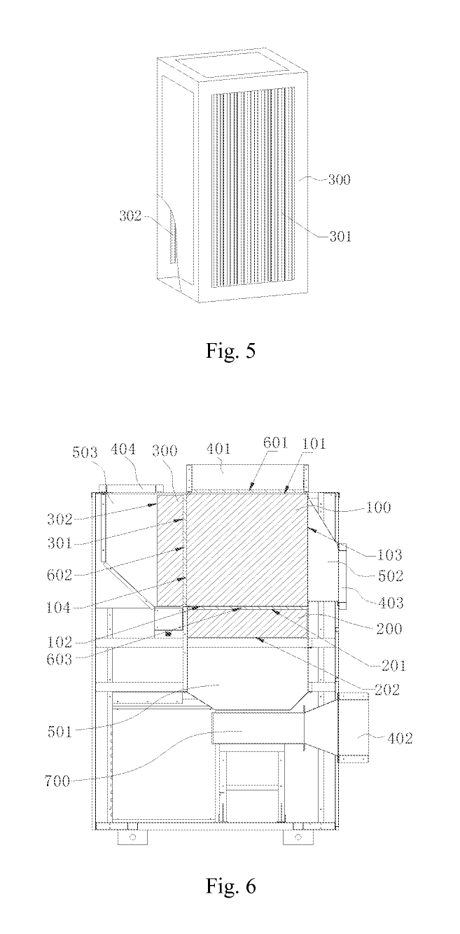

As shown in FIG. 5, there is a specific embodiment of an evaporator 300 according to the present invention, wherein the evaporator 300 has an evaporator air inlet surface 301 and an evaporator air outlet surface 302. For better understanding, the surface 302 is shown here by the partial cross-section view. The evaporator 300 shown here is cuboid, wherein the surface 301 and the surface 104 have an identical area, and are faced each other.

It should be understood that, the mentioned sensible heat exchanger 100, condenser 200 and evaporator 300 are not limited to be cuboid, instead, it can be any shapes only if each pair of surfaces, i.e. one air inlet surface in one device and corresponding air outlet surface in other device, which are configured to face each other and have an identical area. For example, the condenser air inlet surface 201 and the condenser air outlet surface 202 can be arc-shaped, etc.

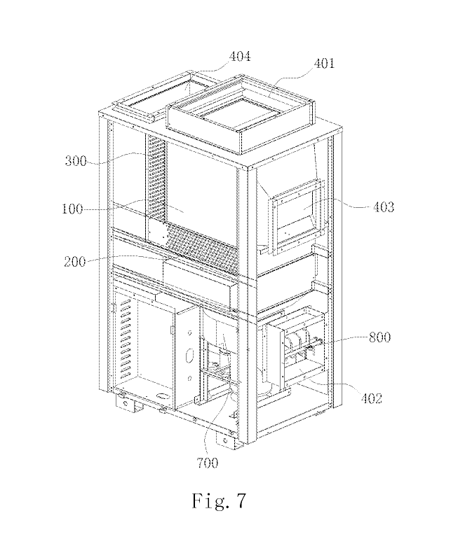

As shown in FIG. 6, a cross-section view of a specific embodiment of drying unit according to the present invention is shown. It can be seen explicitly, the drying unit is further provided with an air inlet 401, an air outlet 402, an air return inlet 403, an air outlet 404 and a condensation fan 700.

The air inlet 401 is configured above the sensible heat exchanger 100, facing towards the fresh-air inlet surface 101. In this embodiment, a first air inlet interval is provided between the air inlet 401 and the fresh-air inlet surface 101, in order to ensure a uniform fresh-air flow to the sensible heat exchanger 100 through the air inlet 401. Some materials can be used to surround the first air inlet interval, to form a first airproof air inlet duct 601.

The condenser 200 is configured horizontally beneath the sensible heat exchanger 100, wherein the condenser air inlet surface 201 and the fresh-air outlet surface 102 are configured to face each other and have an identical area. Further a second air inlet interval is provided between the fresh-air outlet surface 102 and the condenser air inlet surface 201, in order to ensure a uniform heated fresh-air flow to the condenser 200 through the fresh-air outlet surface 102. Some materials can be used to surround the second air inlet interval, to form a second airproof air inlet duct 603. The heated fresh air is further heated when entering the condenser 200, then is blown out by the condensation fan 700 that is connected to the condenser air outlet surface 202, to the drying chamber (not shown) through the air outlet 402. Preferably, an air guide ring 501 is configured between the condensation fan 700 and the condenser air outlet surface 202.

The air return inlet 403 is configured at right side of the sensible heat exchanger 100, facing towards the return-air inlet surface 103. In this embodiment, a return-air guide ring 502 is configured between the return-air inlet surface 103 and the air return inlet 403, for uniformly inducing the return air from the air return inlet 403 to the return-air inlet surface 103.

The evaporator 300 is configured vertically at left side of the sensible heat exchanger 100, in which the evaporator air inlet surface 301 and the return-air outlet surface 104 are configured to face each other and have an identical area. In this embodiment, an air return interval is provided between the return-air outlet surface 104 and the evaporator air inlet surface 301, in order to ensure a uniform cooled return-air flow to the evaporator 300. Some materials can be used to surround the air return interval, to form an airproof air return duct 602. Further an exhaust guide ring 503 is configured between the air outlet surface 302 and the air outlet 404.

It should be understood that, the mentioned materials surrounding the first air inlet interval, the second air inlet interval and the air return interval, can be, but is not limited to, a sealing sponge. Any materials capable of airproofing the first air inlet interval, the second air inlet interval and the air return interval will be fallen into the scope of the present invention.

The drying heat pump system for printing press according to the present invention, eliminated the complicated design for ducts between the sensible heat exchanger 100 and the air inlet, ducts between the sensible heat exchanger 100 and the condenser 200, ducts between the sensible heat exchanger 100 and the evaporator 300, in the prior art. Instead, the present invention is configured in the manner of that the fresh-air inlet surface 101 and the air inlet 401 are configured to face each other, the fresh-air outlet surface 102 and the condenser air inlet surface 201 are configured to face each other and have an identical area, the return-air outlet surface 104 and the evaporator air inlet surface 301 are configured to face each other and have an identical area. Thus, the fresh air enters the fresh-air inlet surface 101, then enters the condenser air inlet surface 201 through the fresh-air outlet surface 102, and the return air enters the evaporator air inlet surface 301 through the return-air outlet surface 104. The present invention has a compact structure and a simple arrangement, and eliminates complicated ducts design, such structure and arrangement reduce wind resistance and greatly improve the efficiencies of air flow/heat recovery.

Furthermore, the first air inlet duct 601, formed by airproof materials surrounding the first air inlet interval, is configured between the air inlet 401 and the fresh-air inlet surface 101; the second air inlet duct 603, formed by airproof materials surrounding the second air inlet interval, is configured between the fresh-air outlet surface 102 and the condenser air inlet surface 201; the air return duct 602, formed by airproof materials surrounding the air return interval, is configured between the return-air outlet surface 104 and the evaporator air inlet surface 301. Also, the condenser air inlet surface 201 and the fresh-air outlet surface 102 have an identical area, and the return-air outlet surface 104 and the evaporator air inlet surface 301 have an identical area. This ensures that air can enter the sensible heat exchanger 100, the condenser 200 and the evaporator 300 uniformly, and energy consumption due to wind resistance can be reduced.

As shown in FIG. 7, a perspective view of a drying heat pump system for printing press, according to the present invention, is shown, wherein the system comprises an air volume detector which comprises a duct 800 and a differential pressure transmitter connected to the duct 800. The duct 800 is configured at the air outlet 402, and the differential pressure transmitter (not shown) is provided outside. The duct 800 receives a full pressure and a static pressure in the air flow, and two pressures will be reflected on the differential pressure transmitter, then the differential pressure transmitter calculates the difference about two pressures to obtain a value of dynamic pressure, and transmits this value to a controller. The controller will then calculate a wind velocity based on the dynamic pressure, the required air volume can be obtained by the wind velocity multiplying area of the air outlet. Based on the required air volume, the actual air volume may be adjusted. The embodiment can adjust the air volume precisely, and save energy.

In a preferred embodiment, the air inlet 401 and the air outlet 404 are both provided on an identical side of the drying unit. As shown in FIG. 7, one air inlet 401 and one air outlet 404 are provided on the top of the drying unit, and they are rectangle-shaped. The air inlet 401 has a dimension of 600×600 mm, while the air outlet 404 has a dimension of 600×300 mm.

In an alternate preferred embodiment, the air outlet 402 and the air return inlet 403 are also both provided on an identical side of the drying unit. As shown in FIG. 7, the air outlet 402 and the air return inlet 403 are provided at right side of the unit, and they are rectangle-shaped. The air outlet 402 has a dimension of 350×300 mm, while the air return inlet 403 has a dimension of 380×300 mm.

It should be understood that, the size and shape of the air inlet 401, the air outlet 402, the air return inlet 403 and the air outlet 404 are not limited to those mentioned above, it could be optionally selected according to actual needs instead. Any size and shape thereof making a convenient connection with external ducts or members would be fallen into the scope of the present invention.

Certainly, the embodiments described hereinbefore are merely preferred embodiments of the present invention and not for purposes of any restrictions or limitations on the invention. It will be apparent that any non-substantive, obvious alterations or improvement by the technician of this technical field according to the present invention may be incorporated into ambit of claims of the present invention.

1. A drying heat pump system for printing press, comprising a drying unit, wherein said drying unit comprise
a sensible heat exchanger having a fresh-air inlet surface, a fresh-air outlet surface being opposite to the fresh-air inlet surface, a return-air inlet surface, and a return-air outlet surface being opposite to the return-air inlet surface; an air inlet is configured in the drying unit, facing towards the fresh-air inlet surface, and an air return inlet is configured in the drying unit, facing towards the return-air inlet surface;
a condenser having a condenser air inlet surface, the condenser air inlet surface and the fresh-air outlet surface are configured to face each other and have an identical area; and
an evaporator having an evaporator air inlet surface, the evaporator air inlet surface and the return-air outlet surface are configured to face each other and have an identical area.

2. The system of claim 1, wherein a first air inlet interval is provided between the air inlet and the fresh-air inlet surface, and an airproof material is used to surround the first air inlet interval, to form a first airproof air inlet duct.

3. The system of claim 2, wherein a second air inlet interval is provided between the fresh-air outlet surface and the condenser air inlet surface, and an airproof material is used to surround the second air inlet interval, to form a second airproof air inlet duct.

4. The system of claim 3, wherein an air return interval is provided between the return-air outlet surface and the evaporator air inlet surface, and an airproof material is used to surround the air return interval, to form an airproof air return duct.

5. The system of claim 4, wherein a return-air guide ring is configured between the return-air inlet surface and the air return inlet, for uniformly inducing return air from the air return inlet to the return-air inlet surface.

6. The system of claim 5, wherein the evaporator has an evaporator air outlet surface, and an exhaust guide ring is configured between the evaporator air outlet surface and an air outlet provided in the drying unit.

7. The system of claim 1, wherein the condenser has a condenser air outlet surface, and the drying unit also comprises a condensation fan that is connected to the condenser air outlet surface, an air guide ring is configured between the condensation fan and the condenser air outlet surface.

8. The system of claim 7, wherein
the system comprises an air volume detector which comprises a duct and a differential pressure transmitter connected to the duct; and
the drying unit comprises an air outlet connected to the condensation fan, and the duct is configured at the air outlet.

9. The system of claim 8, wherein the air outlet and the air return inlet are both provided on an identical side of the drying unit.

10. The system of claim 9, wherein the air inlet and the air outlet are both provided on an identical side of the drying unit.
